(19) United States
(12) Patent Application Publication
(10) Pub. No.: US 2018/0259766 A1
(43) Pub. Date: Sep. 13, 2018

(54) OPTICAL SCANNING APPARATUS

(71) Applicants: KABUSHIKI KAISHA TOSHIBA, Tokyo (JP); TOSHIBA TEC KABUSHIKI KAISHA, Tokyo (JP)

(72) Inventor: Sueo UENO, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/669,581

(22) Filed: Aug. 4, 2017

(30) Foreign Application Priority Data
Mar. 10, 2017 (JP) 2017-046512

(51) Int. Cl. G02B 26/10; G02B 26/08

(52) U.S. Cl. CPC G02B 26/105; G02B 26/0833

(57) ABSTRACT

An optical scanning apparatus comprises a MEMS mirror section configured to distribute abeam in a predetermined range by resonance vibration; a light receiving section configured to receive the beam and converts it to an electric signal; a first reflection section, arranged at one end of the predetermined range, configured to reflect the beam reflected by the MEMS mirror section towards the light receiving section; a second reflection section, arranged at the other end of the predetermined range and on which the beam reflected by the MEMS mirror section is incident, configured to reflect the incident beam by separating the incident beam into two beams having different propagation paths in such a manner that beam spots thereof in the light receiving section are overlapped; and a CPU input section having one CPU port and in which the electric signal converted by the light receiving section is input.

### CROSS-REFERENCE TO RELATED APPLICATION

This application is based upon and claims the benefit of priority from Japanese Patent Application No. 2017-046512, filed Mar. 10, 2017, the entire contents of which are incorporated herein by reference.

### FIELD

Embodiments described herein relate generally to an optical scanning apparatus.

### BACKGROUND

Conventionally, a laser scanner unit provided with a MEMS mirror instead of a polygon is proposed. However, if the MEMS mirror vibrates in resonance, it becomes difficult to determine whether the MEMS mirror starts an operation at left or right of a movable range of the MEMS mirror. As a result, it is known that the determination of the direction of printing is difficult. Such a problem is resolved by arranging photodiodes at both ends in a main scanning direction of a laser light reflected by the MEMS mirror. In such an arrangement, by inputting a reception signal to individual input port of a CPU, it is possible to determine a start direction. However, such a method has the possibility of using two input ports of the CPU and requiring a complicated calculation inside the CPU for two inputs.

### DESCRIPTION OF THE DRAWINGS

FIG. 1 is a diagram exemplifying an optical scanning apparatus 1;

FIG. 2 is a side view of a reflection mirror section 13 in a case of rotating a second half size reflection plate 132 with respect to a first half size reflection plate 131 in a XY plane;

FIG. 3 is a bird's eye view of the reflection mirror section 13 in a case of rotating the second half size reflection plate 132 with respect to the first half size reflection plate 131 in the XY plane;

FIG. 4 is a diagram illustrating the relationship between a resonance vibration of a MEMS mirror and a generated pulse train according to a first embodiment;

FIG. 5 is a sectional view of the reflection mirror section 13 in a case of moving the second half size reflection plate 132 in parallel with the first half size reflection plate 131 in the XY plane;

FIG. 6 is a bird's eye view of the reflection mirror section 13 in a case of moving the second half size reflection plate 132 in parallel with the first half size reflection plate 131 in the XY plane;

FIG. 7 is a diagram exemplifying an optical scanning apparatus 2 according to an embodiment;

FIG. 8 is a diagram illustrating a state in which an incident light is reflected by a first half Fresnel reflection plate 231 and a second half Fresnel reflection plate 232 having a structure of a Fresnel surface different from that of the first half Fresnel reflection plate 231;

FIG. 9 is a bird's eye view of a Fresnel mirror section 23 including the first half Fresnel reflection plate 231 and the second half Fresnel reflection plate 232 having a structure of a Fresnel surface different from that of the first half Fresnel reflection plate 231;

FIG. 10 is a diagram illustrating the relationship between a resonance vibration of a MEMS mirror and a generated pulse train according to a second embodiment;

FIG. 11 is a view illustrating that spatial distribution of intensity of incident light on a Fresnel mirror changes by reflection;

FIG. 12 is a view illustrating chattering phenomenon caused by a beam reflected by the Fresnel mirror;

FIG. 13 is a diagram exemplifying a structure including a chattering phenomenon suppression method in the optical scanning apparatus 2 according to an embodiment;

FIG. 14 is a diagram illustrating a pulse generated by a beam passing through a capacitor lens section 27;

FIG. 15 is a diagram exemplifying the structure of an optical scanning apparatus 3 according to an embodiment;

FIG. 16 is a side view illustrating an intermediate member 38 in a state of rotating a second half intermediate member 382 with respect to a first half intermediate member 381 having the same material and the same surface structure in the XY plane;

FIG. 17 is a bird's eye view of the intermediate member 38 in a state of rotating the second half intermediate member 382 with respect to the first half intermediate member 381 in the XY plane;

FIG. 18 is a diagram illustrating the relationship between a resonance vibration of a MEMS mirror and a generated pulse train according to a third embodiment;

FIG. 19 is a sectional view illustrating the intermediate member 38 in a state of moving the second half intermediate member 382 in parallel with the first half intermediate member 381 having the same material and the same surface structure in the XY plane;

FIG. 20 is a bird's eye view illustrating the intermediate member 38 in a state of moving the second half intermediate member 382 in parallel with the first half intermediate member 381 having the same material and the same surface structure in the XY plane;

FIG. 21 is a diagram illustrating a state of refraction of an incident beam by a third half intermediate member 383 obtained by using a Fresnel surface as a surface of the first half intermediate member 381 and a fourth half intermediate member 384 obtained by using a Fresnel surface as a surface of the second half intermediate member 382 according to the third embodiment;

FIG. 22 is a bird's eye view illustrating the intermediate member 38 having the third half intermediate member 383 and the fourth half intermediate member 384;

FIG. 23 is a diagram exemplifying the structure of an optical scanning apparatus 4 according to an embodiment;

FIG. 24 is a diagram illustrating the relationship between a spot size of a beam spot on a light receiving section 15 and a pulse width of an electric signal generated by the beam; and

FIG. 25 is a diagram illustrating the relationship between the resonance vibration of the MEMS mirror and the generated pulse train in the optical scanning apparatus 4 according to a fourth embodiment.

### DETAILED DESCRIPTION

In accordance with an embodiment, an optical scanning apparatus comprises a MEMS mirror section, a light receiving section, a first reflection section, a second reflection section and a CPU input section. The MEMS mirror section distributes a beam in a predetermined range by resonance vibration. The light receiving section receives the beam and converts it to an electric signal. The first reflection section is arranged at one end of the predetermined range and reflects the beam reflected by the MEMS mirror section towards the light receiving section. The second reflection section which is arranged at the other end of the predetermined range and on which the beam reflected by the MEMS mirror section is incident reflects the incident beam by separating the incident beam into two beams having different propagation paths in such a manner that beam spots in the light receiving section are overlapped. The CPU input section has one CPU port and receives the electric signal converted by the light receiving section.

Hereinafter, an optical scanning apparatus of an embodiment is described with reference to the accompanying drawings.

### First Embodiment

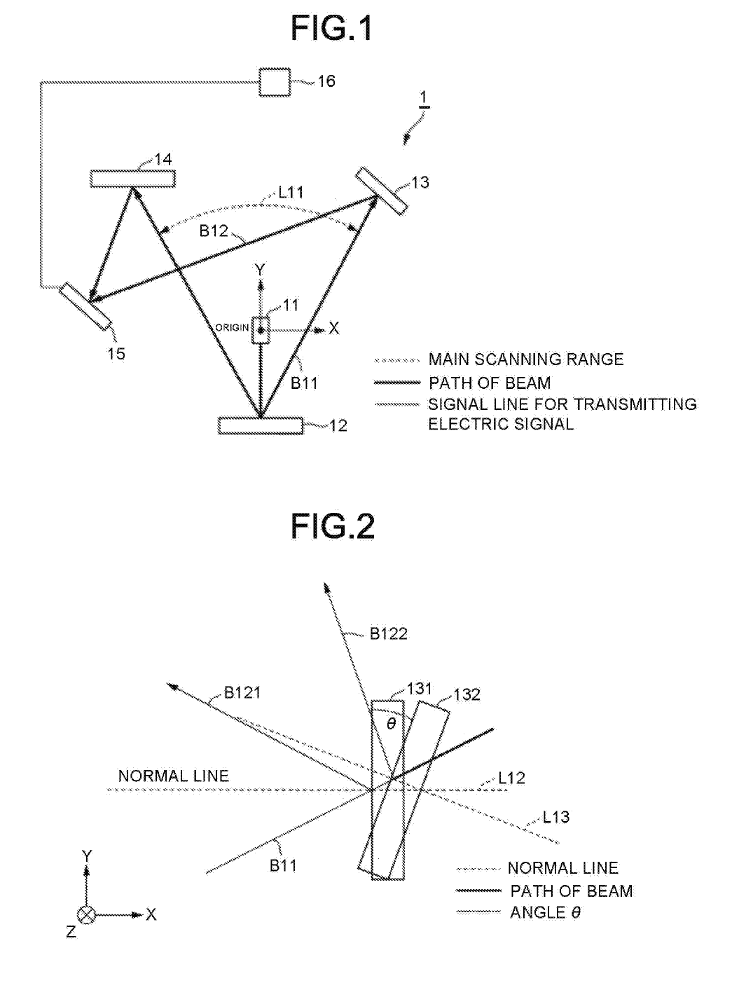

FIG. 1 is a diagram exemplifying the structure of an optical scanning apparatus 1 according to an embodiment. The optical scanning apparatus 1 of the embodiment may be, for example, a multi-function peripheral (image forming apparatus), or a device such as a projector. The optical scanning apparatus 1 includes a light source section 11, a MEMS mirror section 12, a reflection mirror section 13 as a first reflection section, a beam reflection plate 14 as a second reflection section, a light receiving section 15 and a CPU input section 16. XY coordinates are defined as shown in FIG. 1, and an origin is the center of the light source section 11. A thick arrow in FIG. 1 shows a path of a beam. A dotted line arrow L11 in FIG. 1 indicates a main scanning range of the beam reflected by the MEMS mirror section 12. A thin solid line in FIG. 1 indicates a signal line passing through an electric signal.

The light source section 11 may be, for example, a laser diode. The light source section 11 emits a beam in a negative direction of a Y axis toward the MEMS mirror section 12.

The MEMS mirror section 12 includes a MEMS mirror that vibrates in resonance. The MEMS mirror section 12 distributes the reflection direction of the beam to the left and right according to a displacement of the vibration of the MEMS mirror. In the reflection direction of the beam reflected by the MEMS mirror, the reflection direction in a case in which an X axis component of the propagation direction of the reflected beam is positive is referred to as a “positive reflection direction” below. In the reflection direction of the beam reflected by the MEMS mirror, the reflection direction if the X axis component of the propagation direction of the reflected beam is negative is referred to as a “negative reflection direction” below.

The reflection mirror section 13 has a first half size reflection plate 131 as a first mirror and a second half size reflection plate 132 as a second mirror. The first half size reflection plate 131 and the second half size reflection plate 132 are mirrors. The sizes and shapes of the first half size reflection plate 131 and the second half size reflection plate 132 are the same. The first half size reflection plate 131 and the second half size reflection plate 132 have different space arrangements. The reflection mirror section 13 reflects a beam (hereinafter, referred to as a “mirror section incident beam B11 ”) reflected in the positive reflection direction by the MEMS mirror section 12 with the first half size reflection plate 131 and the second half size reflection plate 132.

The beam reflection plate 14 is a reflection plate of the beam. The beam reflection plate 14 reflects the beam reflected in the negative reflection direction by the MEMS mirror section 12.

The light receiving section 15 may be, for example, a photodiode. The light receiving section 15 receives the beam (hereinafter referred to as “mirror section reflected beam B12”) reflected by the reflection mirror section 13 and a beam reflected by the beam reflection plate 14. The light receiving section 15 transmits a time change of the intensity of the received light to the CPU input section 16 as a binary electric signal.

The CPU input section 16 may be an input port of a CPU. The CPU input section 16 acquires the electric signal generated by the light receiving section 15.

FIG. 2 is a side view of the reflection mirror section 13 in a case of rotating the second half size reflection plate 132 with respect to the first half size reflection plate 131 in a XY plane. XYZ coordinates in FIG. 2 are as shown in FIG. 2, but X and Y axes may be different from those in FIG. 1. The first half size reflection plate 131 and the second half size reflection plate 132 are arranged in such a manner that the planes thereof on which the beams are incident form an angle θ. The mirror section reflected beam B12 has a first mirror section reflected beam B121 and a second mirror section reflected beam B122 having different propagation directions. The mirror section incident beam B11 is reflected by the first half size reflection plate 131 to be propagated as the first mirror section reflected beam B121. The mirror section incident beam B11 is reflected by the second half size reflection plate 132 to be propagated as the second mirror section reflected beam B122. In FIG. 2, a dotted line L12 indicates a normal line to a surface of the first half size reflection plate 131. In FIG. 2, a dotted line L13 indicates a normal line to a surface of the second half size reflection plate 132.

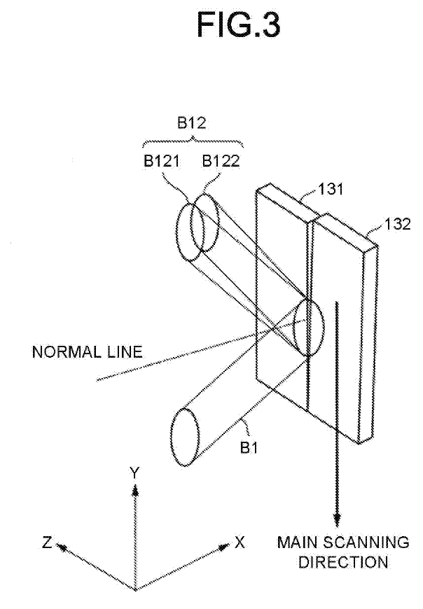

FIG. 3 is a bird's eye view of the reflection mirror section 13 in a case of rotating the second half size reflection plate 132 shown in FIG. 2 with respect to the first half size reflection plate 131 in the XY plane. The XYZ coordinates in FIG. 3 are the XYZ coordinates shown in FIG. 2. The mirror section incident beam B11 is incident on the reflection mirror section 13 in such a manner that a spot center of the mirror section incident beam B11 is on a boundary between the first half size reflection plate 131 and the second half size reflection plate 132. Therefore, half of the mirror section incident beam B11 is reflected by the first half size reflection plate 131, and the other half of the mirror section incident beam B11 is reflected by the second half size reflection plate 132. A “main scanning direction” shown in FIG. 3 indicates a direction in which a laser spot is scanned by the vibration of the MEMS mirror. Hereinafter, in all figures, the “main scanning direction” described in the diagrams indicates a direction in which the laser spot is scanned by the vibration of the MEMS mirror.

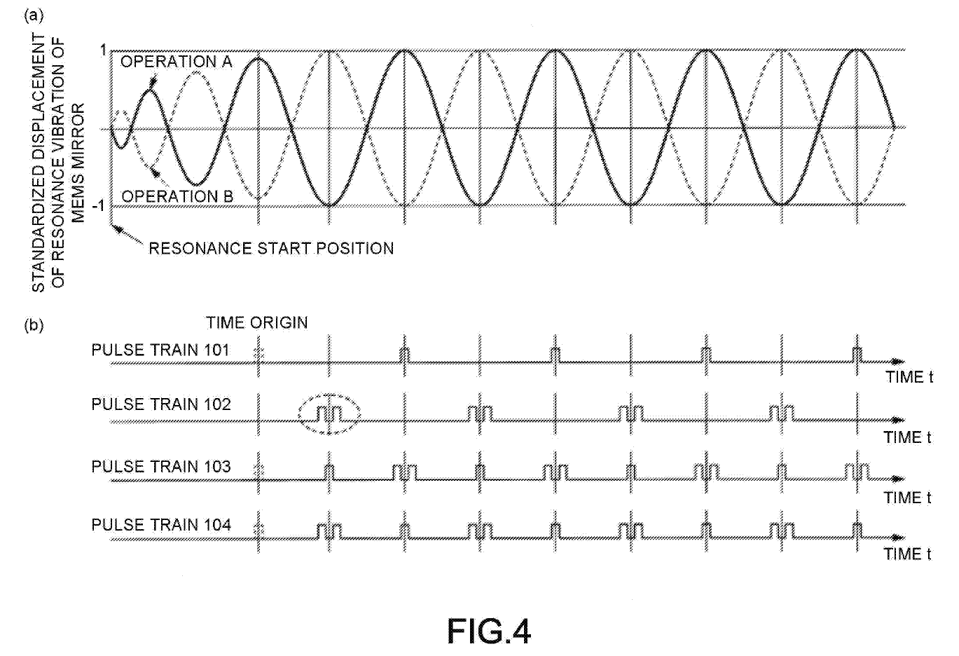

FIG. 4 is a diagram illustrating the relationship between a resonance vibration of the MEMS mirror and a generated pulse train according to the first embodiment. As shown in FIG. 2 and FIG. 3, the mirror section incident beam B11 incident on the reflection mirror section 13 is propagated as two reflected beams with different propagation directions. Therefore, the beam reflected in the positive reflection direction by the MEMS mirror section 12 becomes two beams having an optical path difference to be incident on the light receiving section 15. The beams incident on the light receiving section 15 are converted to a binary electric signal and then input to the CPU input section 16. The electric signal input to the CPU input section 16 is displayed on a display device (not shown) as a pulse train via an information processing device (not shown) such as a personal computer connected to the CPU input section 16.

Therefore, the beams reflected in the positive reflection direction by the MEMS mirror section 12 are displayed on the display section (not shown) as two pulse signals (hereinafter referred to as “2 division pulses”) like a pulse enclosed by the dotted line in FIG. 4

FIG. 4(a) shows standardized displacement of the resonance vibration of the MEMS mirror. The displacement is a position of the MEMS mirror. The state of the vibration changes depending on whether the resonance vibration of the MEMS mirror starts vibrating from a position where the beam is reflected in the negative reflection direction or vibrating from a position where the beam is reflected in the positive reflection direction. The vibration (hereinafter, referred to as “operation A”) shown by a solid line shows a state of the vibration at the time of starting vibration from the position where the beam is reflected in the negative reflection direction. The vibration (hereinafter, referred to as “operation B”) indicated by a dotted line indicates a state of the vibration at the time of starting vibration from the position where the beam is reflected in the positive reflection direction.

FIG. 4(b) shows a pulse train (hereinafter, referred to as a “pulse train 101”) generated only by the beam reflected in the negative reflection direction by the MEMS mirror section 12, a pulse train (hereinafter, referred to as a “pulse train 102”) generated only by the beam reflected in the positive reflection direction by the MEMS mirror section 12, a pulse train (hereinafter, referred to as a “pulse train 103”) generated at the time of the operation A, and a pulse train (hereinafter, referred to as a “pulse train 104”) generated at the time of the operation B. A time origin is a time at which the pulse is first generated by exceeding a threshold value of detection. At the time the pulse is generated, amplitude of the resonance vibration of the MEMS mirror is large and the beam reflected by the reflection mirror section 13 or the beam reflection plate 14 reaches the light receiving section 15. The pulse train 103 and the pulse train 104 are the pulse trains in which generation timing of two division pulses is different from each other.

In the optical scanning apparatus 1 of the first embodiment constituted as described above, by using only one input port of the CPU, it is possible to distinguish the pulse signal generated by the beam reflected in the positive reflection direction from the pulse signal generated by the beam reflected in the negative reflection direction, and to determine an operation start position of the resonance vibration of the MEMS mirror section 12.

(Modification)

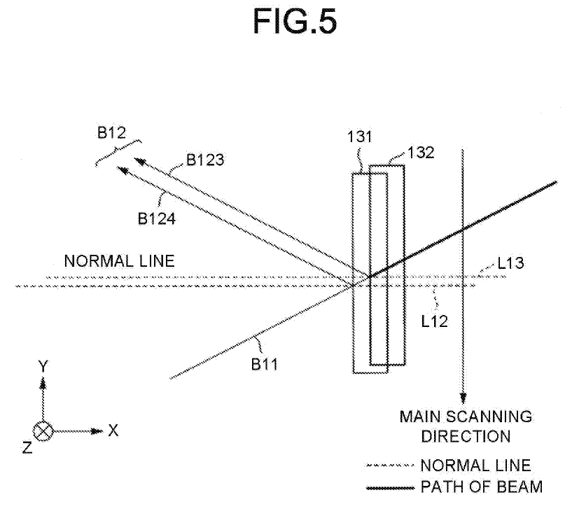

FIG. 5 is a sectional view of the reflection mirror section 13 in a case of moving the second half size reflection plate 132 in parallel with the first half size reflection plate 131 in the XY plane. The XYZ coordinates in FIG. 5 are as shown in FIG. 5, and the X and Y axes may be different from those in FIG. 1. The reflection mirror section 13 has two reflection plates (e.g., the first half size reflection plate 131 and the second half size reflection plate 132) having different reflection directions of the incident beam because of different space arrangements. Therefore, the mirror section incident beam B11 is propagated as the mirror section reflected beam B12 having a third mirror section reflected beam B123 and a fourth mirror section reflected beam B124 having different propagation directions.

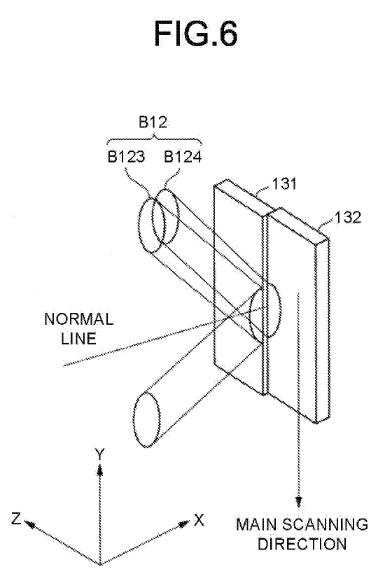

FIG. 6 is a bird's eye view of the reflection mirror section 13 in a case of moving the second half size reflection plate 132 shown in FIG. 5 in parallel with the first half size reflection plate 131 in the XY plane. The XYZ coordinates in FIG. 6 are XYZ coordinates shown in FIG. 5. The mirror section incident beam B11 is incident on the reflection mirror section 13 in such a manner that the spot center of the mirror section incident beam B11 is on the boundary between the first half size reflection plate 131 and the second half size reflection plate 132. Therefore, half of the mirror section incident beam B11 is reflected by the first half size reflection plate 131, and the other half of the first incident beam B11 is reflected by the second half size reflection plate 132.

Therefore, as the reflection mirror section 13, even if the second half size reflection plate 132 of the reflection mirror section 13 is moved in parallel with the first half size reflection plate 131 in the XY plane, two division pulses are generated which is the same as the pulse train as shown in FIG. 4.

In the optical scanning apparatus 1 of the first embodiment constituted as described above, merely by using a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

### Second Embodiment

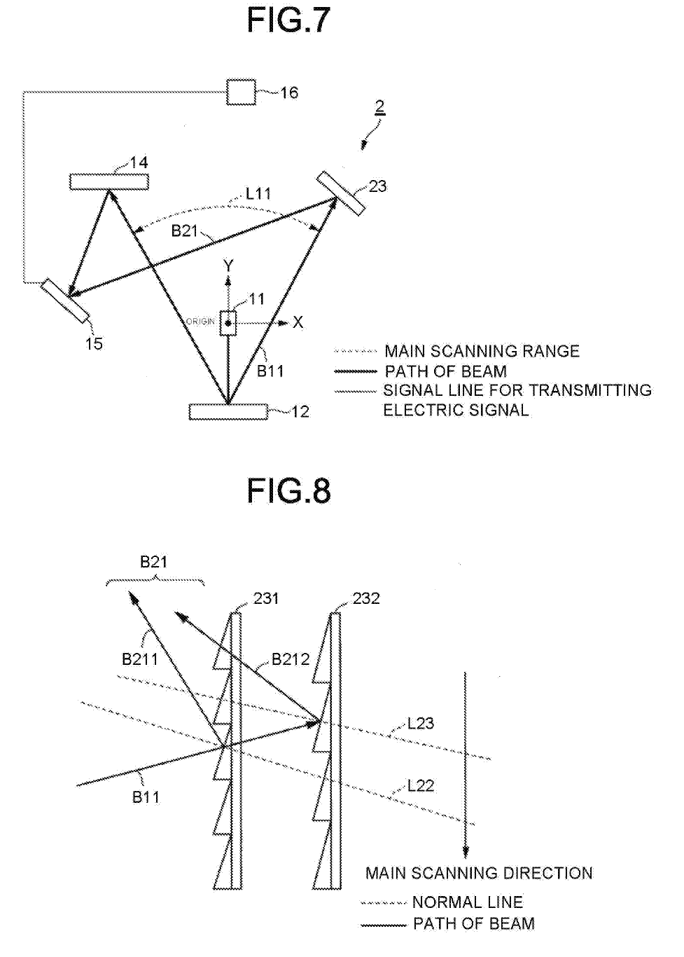

FIG. 7 is a diagram exemplifying the structure of an optical scanning apparatus 2 according to the embodiment. In FIG. 7, those which achieve the same function as the first embodiment are denoted with the same reference numerals and the description thereof is omitted. The optical scanning apparatus 2 has a Fresnel mirror section 23 instead of the reflection mirror section 13 as a component different from the first embodiment.

The Fresnel mirror section 23 has two mirrors, i.e., a first half Fresnel reflection plate 231 and a second half Fresnel reflection plate 232. The first half Fresnel reflection plate 231 and the second half Fresnel reflection plate 232 are mirrors whose surfaces are the Fresnel surfaces. Either or both of the space arrangement and the structure of the Fresnel surface are different for the first half Fresnel reflection plate 231 and the second half Fresnel reflection plate 232. The Fresnel mirror section 23 reflects the mirror section incident beam B11 reflected in the positive reflection direction with the first half Fresnel reflection plate 231 and the second half Fresnel reflection plate 232.

FIG. 8 is a diagram illustrating a state in which an incident light is reflected by the first half Fresnel reflection plate 231 and the second half Fresnel reflection plate 232 of which the structure of the Fresnel surface is different from that of the first half Fresnel reflection plate 231. The first half Fresnel reflection plate 231 and the second half Fresnel reflection plate 232 differ in the structure of the Fresnel surface. Therefore, the mirror section incident beam B11 incident on the Fresnel mirror section 23 is propagated as Fresnel mirror section reflected beams B21 including a first Fresnel mirror reflected beam B211 and a second Fresnel mirror reflected beam B212 having different propagation directions, respectively.

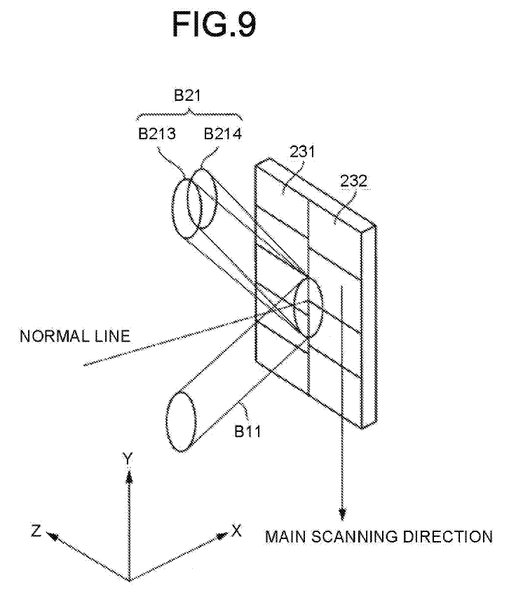

FIG. 9 is a bird's eye view of the Fresnel mirror section 23 including the first half Fresnel reflection plate 231 and the second half Fresnel reflection plate 232 of which the structure of the Fresnel surface is different from that of the first half Fresnel reflection plate 231. The XYZ coordinates in FIG. 9 may be different from the XYZ coordinates shown in FIG. 7. The first half Fresnel reflection plate 231 and the second half Fresnel reflection plate 232 are arranged in contact with each other at the side surfaces in the same XZ plane. The mirror section incident beam B11 is incident on the Fresnel mirror section 23 in such a manner that the center of the beam spot of the mirror section incident beam B11 is on the boundary between the first half Fresnel reflection plate 231 and the second half Fresnel reflection plate 232. Therefore, half of the mirror section incident beam B11 is reflected by the first half Fresnel reflection plate 231 to be propagated as a third Fresnel mirror reflected beam B213. Furthermore, the other half of the mirror section incident beam B11 is reflected by the second half Fresnel reflection plate 232 to be propagated as a fourth Fresnel mirror reflected beam B214.

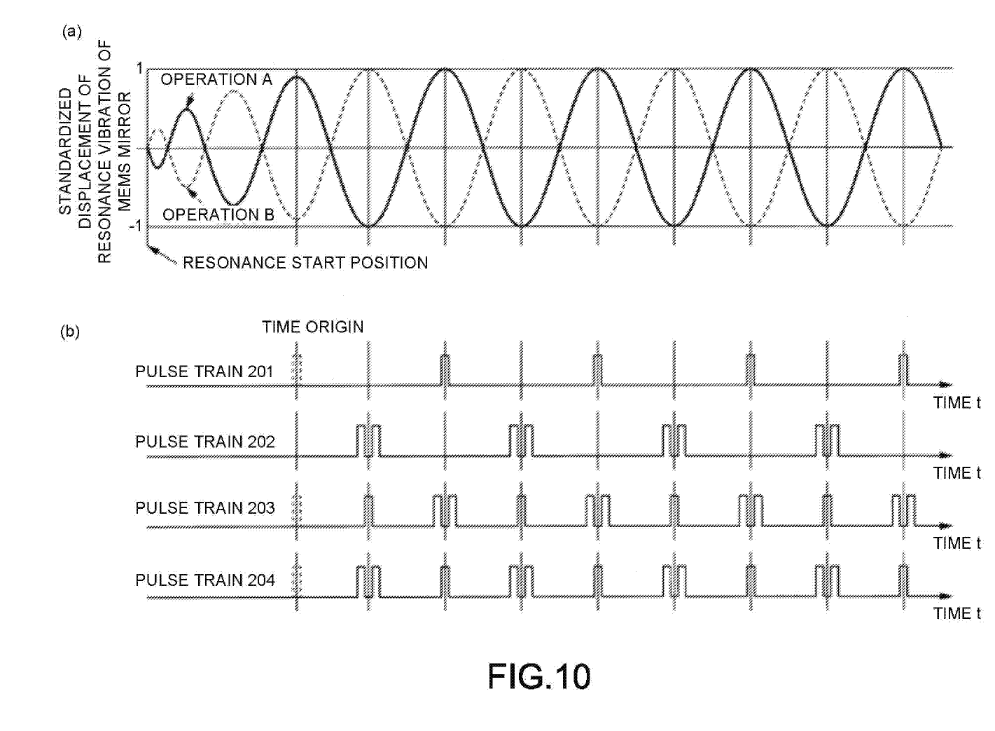

FIG. 10 is a diagram illustrating the relationship between the resonance vibration of the MEMS mirror and the generated pulse train according to the second embodiment. FIG. 10(a) is the same as FIG. 4(a). FIG. 10(a) indicates the standardized displacement of the MEMS mirror. The displacement is the position of the MEMS mirror. As shown in FIGS. 8 and 9, the mirror section incident beam B11 incident on the Fresnel mirror section is propagated as two reflected beams with different propagation directions. Therefore, the beam reflected in the positive reflection direction by the MEMS mirror section 12 becomes two beams having an optical path difference and is incident on the light receiving section 15. The beams incident on the light receiving section 15 are converted to a binary electric signal and then input to the CPU input section 16. The electric signal input to the CPU input section 16 is displayed on the display device (not shown) as the pulse train via the information processing device (not shown) such as a personal computer connected to the CPU input section 16.

Therefore, the beam reflected in the positive reflection direction by the MEMS mirror section 12 is displayed as 2 division pulses on the display section (not shown).

FIG. 10(b) shows a pulse train (hereinafter, referred to as a “pulse train 201”) generated only by the beam reflected in the negative reflection direction by the MEMS mirror section 12, a pulse train (hereinafter, referred to as a “pulse train 202”) generated only by the beam reflected in the positive reflection direction by the MEMS mirror section 12, a pulse train (hereinafter, referred to as a “pulse train 203”) generated at the time of the operation A, and a pulse train (hereinafter, referred to as a “pulse train 204”) generated at the time of the operation B. The pulse train 203 and the pulse train 204 are the pulse trains in which generation timing of generation of 2 division pulses is different from each other.

In the optical scanning apparatus 2 of the second embodiment constituted as described above, by using merely a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

(Modification)

The chattering phenomenon generated in the optical scanning apparatus 2 of the second embodiment and a suppression method thereof are described with reference to the following drawings.

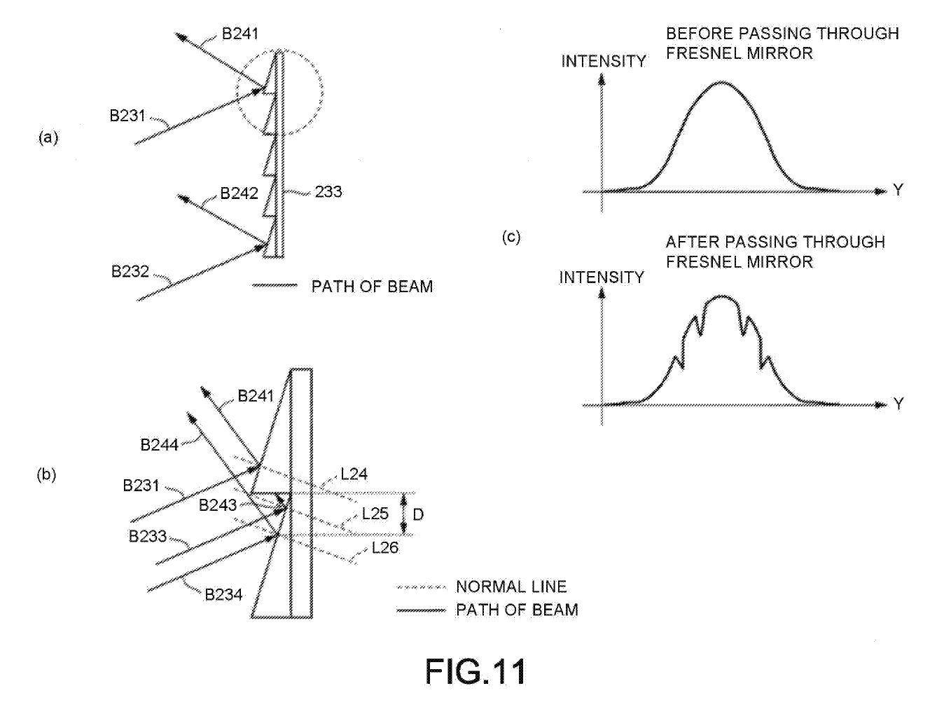

FIG. 11 is a view illustrating that spatial distribution of intensity of the incident light on the Fresnel mirror changes by reflection. The Fresnel mirror structure 233 is a Fresnel mirror.

FIG. 11(a) shows a state in which the incident light B231 and the incident light B232 are incident on the Fresnel mirror structure 233 and are reflected as a reflected light B241 and a reflected light B242. Since there is no block during propagation, the reflected light B241 and the reflected light B242 propagate far away.

FIG. 11(b) is a view obtained by enlarging a part of the Fresnel mirror structure 233 surrounded by a dotted line in FIG. 11(a). The incident light B231, the incident light B233, and the incident light B234 are incident on the Fresnel mirror structure 233. The reflected light B241 of the incident light B231 and the reflected light B244 of the incident light B234 propagate far away because there is no block during propagation. However, the propagation of the reflected light B243 of the incident light B233 is blocked because a part of the Fresnel mirror structure 233 exists during propagation. Therefore, the reflected light B243 is not observed in the distance. The spatial distribution of intensity of the reflected light is different from that of intensity of the incident light because a part of the reflected light is not observed in the distance.

In FIG. 11(c), an upper diagram shows the spatial distribution of intensity of the light incident on the Fresnel mirror structure 233, i.e., Gaussian distribution. A lower diagram shows the spatial distribution of intensity of the light reflected by the Fresnel mirror structure 233. Since the reflection by the Fresnel mirror is blocked, the spatial distribution of intensity of the reflected light is a spatial distribution of intensity of the light with indentations in a part of the Gaussian distribution.

A region D in FIG. 11(b) indicates a region of the Fresnel mirror which causes indentations in the spatial distribution of intensity of the light mentioned above. The region D is generally referred to as an ineffective region.

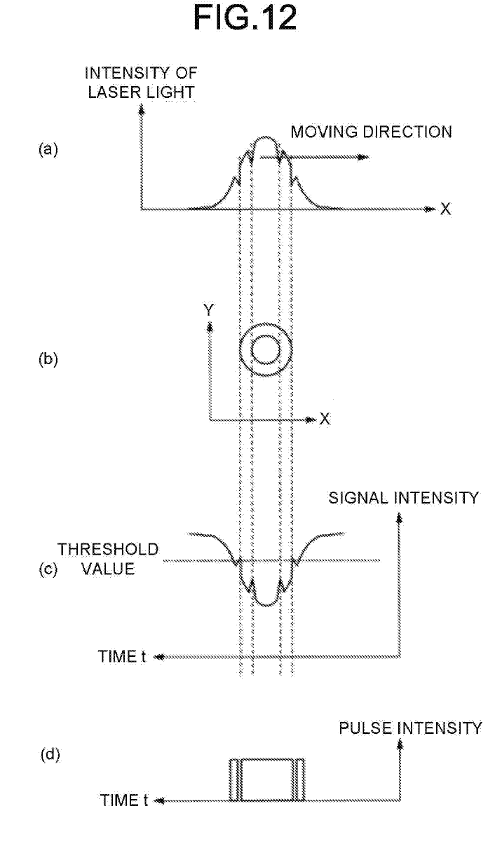

FIG. 12 is a view illustrating the chattering phenomenon caused by a beam reflected by the Fresnel mirror. XY coordinates in FIG. 12 may be different from those in FIG. 11.

FIG. 12(a) shows a state in which the beam reflected by the Fresnel mirror structure 233 is propagated at a certain speed in X axis positive direction. Since the beam is propagated at a certain speed in the X axis positive direction, the electric signal converted by a photo-detector such as the photodiode has a spectrum on the time axis reflecting the spatial distribution of intensity of the beam. The X axis in FIG. 12(a) may be different from the X axis in XYZ coordinates shown in FIG. 9 or FIG. 7.

FIG. 12(b) shows a vertex of the indentation of the intensity distribution of the beam spot on the XY coordinates. The X axis or Y axis in FIG. 12(b) may be different from that of XYZ coordinates shown in FIG. 9 or FIG. 7.

FIG. 12(c) shows the relationship between the electric signal reflecting the intensity of the beam received by the light receiving section 15 and a binary threshold value indicated by the dotted line. The horizontal axis is time. As shown in FIG. 12(c), the intensity of the signal crosses over the threshold value twice at the indentation because it is a distribution with indentations instead of a clean Gaussian signal. Since binarization is performed by the intensity of the signal crossing over the threshold value, in the case of a Gaussian distribution in which the input signal has indentations, a plurality of pulses is generated from one input signal. This is generally referred to as the chattering phenomenon.

FIG. 12(d) shows the pulse shape generated by the chattering phenomenon. Despite the input signal is one signal shown in FIG. 12(a), a plurality of pulses is generated.

The suppression method of the chattering phenomenon in the present embodiment is described with reference to the accompanying drawings below.

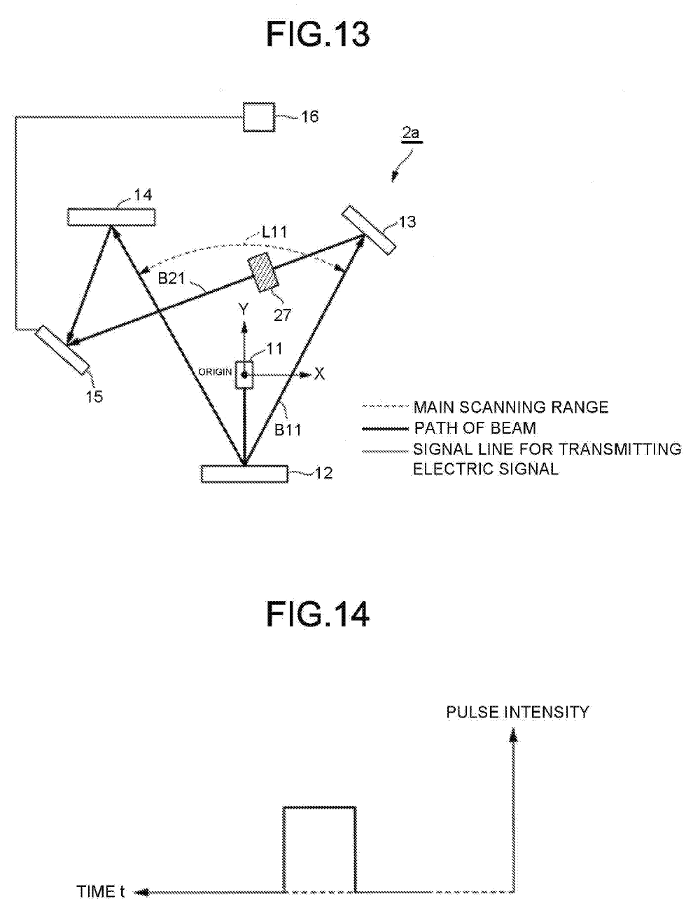

FIG. 13 is a diagram exemplifying the constitution including the chattering phenomenon suppression method in the optical scanning apparatus 2 according to an embodiment. The embodiment below is referred to as an optical scanning apparatus 2a.

The optical scanning apparatus 2a of the embodiment includes a capacitor lens section 27. The capacitor lens section 27 is a capacitor lens. The capacitor lens section 27 exists in an optical path of the Fresnel mirror section reflected beam B21. The capacitor lens section 27 averages the spatial distribution of the intensity of the beam to make the spatial distribution of the intensity of the beam a Gaussian distribution without indentations.

FIG. 14 shows a pulse generated by the beam passing through the capacitor lens section 27. The generated pulse is not a plurality of pulses but one pulse.

In the optical scanning apparatus 2a of the second embodiment arranged as described above, by using merely a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

### Third Embodiment

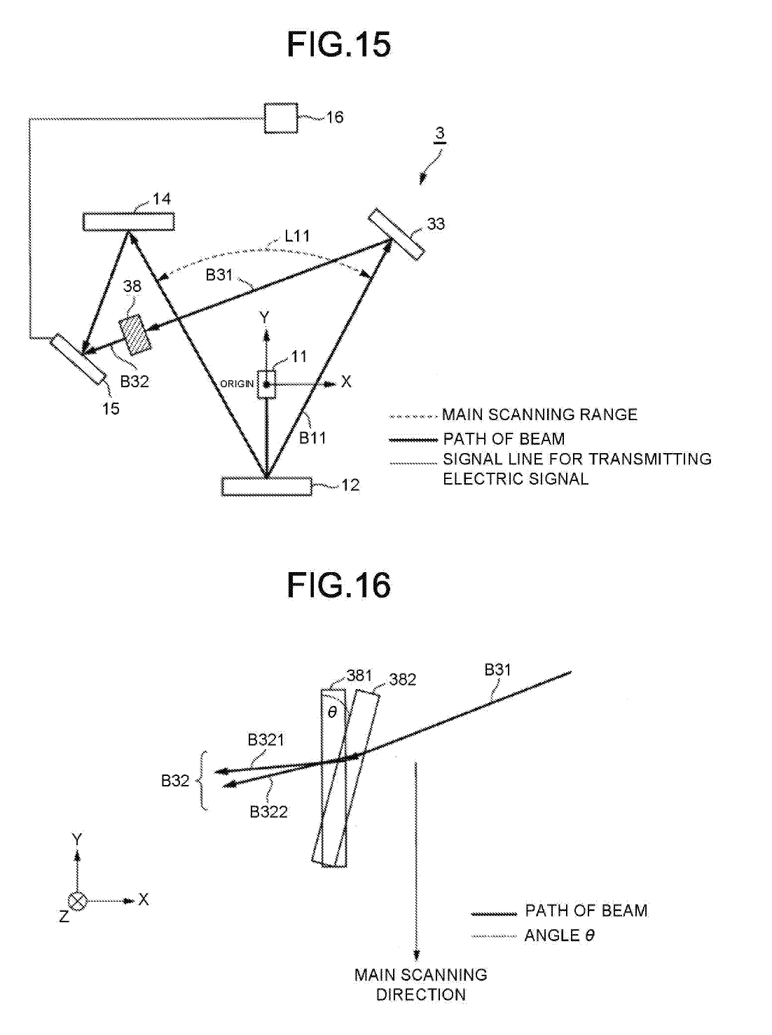

FIG. 15 is a diagram exemplifying the constitution of an optical scanning apparatus 3 according to an embodiment. In FIG. 15, those which achieve the same function as the first embodiment are denoted with the same reference numerals and description thereof is omitted. The optical scanning apparatus 3 includes a reflection section 33 and an intermediate member 38 as components different from the first embodiment.

The reflection section 33 has a single mirror, which is different from the reflection section 13 of the first embodiment. Therefore, a beam (hereinafter, referred to as a “reflection section reflected beam B31”) reflected by the reflection section 33 is not a plurality of beams which is different from the first embodiment.

The intermediate member 38 has, for example, a structure having a high transmittance such as a glass plate. The intermediate member 38 is located between the reflection section 33 and the light receiving section 15 and is located in the optical path of the reflection section reflected beam B31. The intermediate member 38 includes a first half intermediate member 381 and a second half intermediate member 382. The first half intermediate member 381 and the second half intermediate member 382 are the same in material, but either or both of the space arrangement and the surface structure thereof are different. The intermediate member 38 changes the reflection section reflected beam B31 to a transmitted light B32. The first half intermediate member 381 and the second half intermediate member 382 divide the reflection section reflected beam B31 into two beams having different propagation directions.

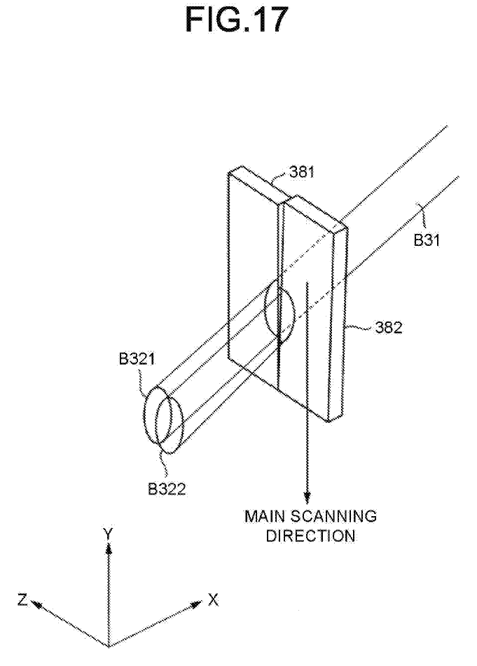

FIG. 16 is a side view illustrating the intermediate member 38 in a case of rotating the second half intermediate member 382 with respect to the first half intermediate member 381 having the same material and the same surface structure in the XY plane. The XYZ coordinates in FIG. 16 are as shown in FIG. 16, and X and Y axes may be different from those in FIG. 15. The first half intermediate member 381 and the second half intermediate member 382 are arranged in such a manner that planes on which the beams enter form an angle θ. The reflection section reflected beam B31 passes through the first half intermediate member 381 and becomes a transmitted light B331. The reflection section reflected beam B31 passes through the second half intermediate member 382 and becomes a transmitted light B332. The transmitted light B331 and the transmitted light B332 have different propagation directions because the first half intermediate member 381 and the second half intermediate member 382 have different space arrangements.

FIG. 17 is a bird's eye view of the intermediate member 38 in a case of rotating the second half intermediate member 382 with respect to the first half intermediate member 381 in the XY plane. XYZ coordinates in FIG. 17 are XYZ coordinates shown in FIG. 16. The reflection section reflected beam B31 is incident on the intermediate member 38 in such a manner that the center of a laser spot of the reflection section reflected beam B31 is on the boundary between the first half intermediate member 381 and the second half intermediate member 382. Therefore, one half of the reflection section reflected beam B31 is refracted by the first half intermediate member 381.

Furthermore, the other half of the reflection section reflected beam B31 is refracted by the second half intermediate member 382.

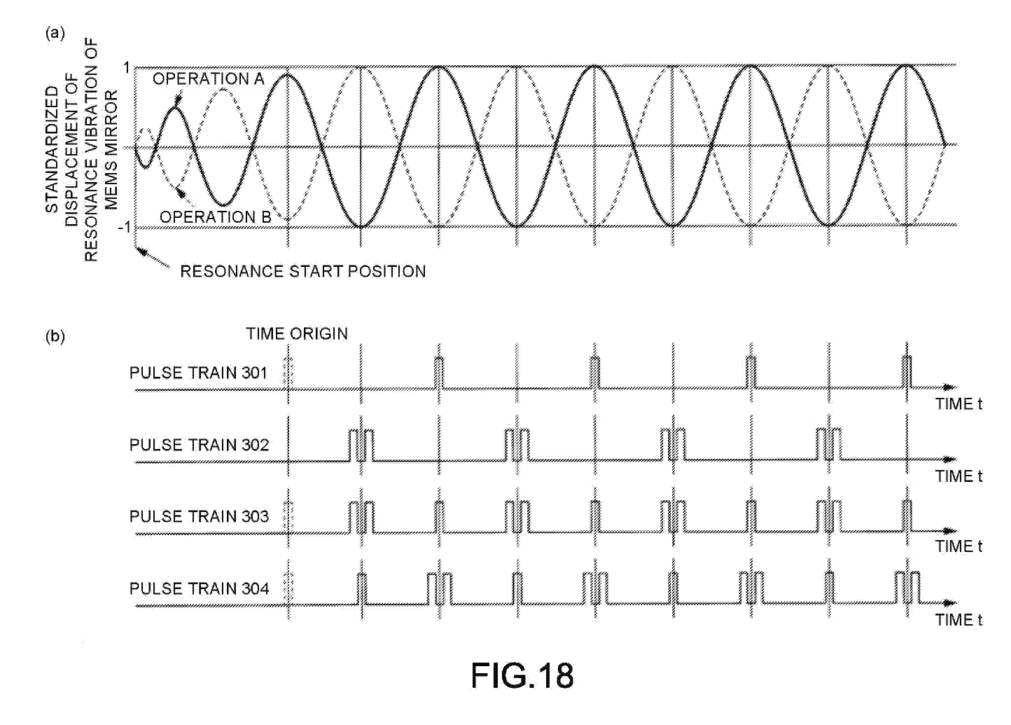

FIG. 18 is a diagram illustrating the relationship between the resonance vibration of the MEMS mirror and the generated pulse train according to the third embodiment. As shown in FIGS. 16 and 17, the reflection section reflected beam B31 incident on the intermediate member 38 is refracted and propagated as two beams with different propagation directions. Therefore, the beam reflected in the positive reflection direction by the MEMS mirror section 12 is incident on the light receiving section 15 as two beams having an optical path difference. The beams incident on the light receiving section 15 are converted to a binary electric signal and then input to the CPU input section 16. The electric signal input to the CPU input section 16 is displayed on the display device (not shown) as the pulse train via the information processing device (not shown) such as a personal computer connected to the CPU input section 16.

Therefore, the beam reflected in the positive reflection direction by the MEMS mirror section 12 is displayed as 2 division pulses on the display section (not shown).

FIG. 18(b) shows a pulse train (hereinafter, referred to as a “pulse train 301”) generated only by the beam reflected in the negative reflection direction by the MEMS mirror section 12, a pulse train (hereinafter, referred to as a “pulse train 302”) generated only by the beam reflected in the positive reflection direction by the MEMS mirror section 12, a pulse train (hereinafter, referred to as a “pulse train 303”) generated at the time of the operation A, and a pulse train (hereinafter, referred to as a “pulse train 204”) generated at the time of the operation B. The pulse train 303 and the pulse train 304 are the pulse trains in which generation timing of generation of 2 division pulses is different from each other.

In the optical scanning apparatus 3 of the third embodiment constituted as described above, by using merely a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

(Modification)

In the third embodiment, the position of the second half intermediate member 382 may be a position after moving within the XY plane in parallel with the position of the first half intermediate member 381.

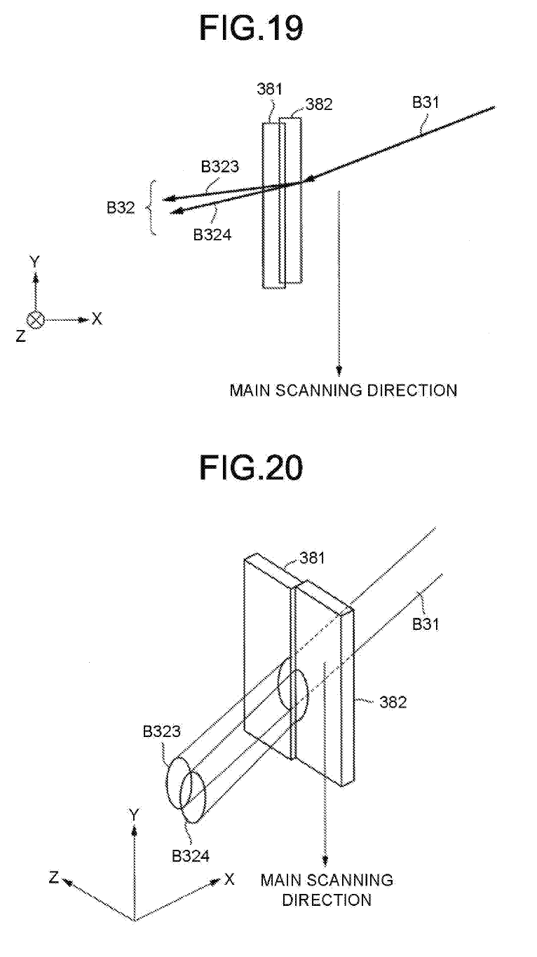

FIG. 19 is a sectional view illustrating the intermediate member 38 in a case of moving the second half intermediate member 382 in parallel with the first half intermediate member 381 having the same material and the same surface structure in the XY plane. XYZ coordinates in FIG. 19 are as shown in FIG. 19, and X and Y axes may be different from those in FIG. 15. In the intermediate member 38 of the optical scanning apparatus 3 in FIG. 15, if the first half intermediate member 381 and the second half intermediate member 382 have different space arrangements, the incident beam becomes two beams having different refraction directions. Therefore, the space arrangement may be an arrangement in which the first half intermediate member 381 and the second half intermediate member 382 may be shifted by translation. In FIG. 19, the transmitted light B32 has a transmitted light B323 and a transmitted light B324 having different propagation directions.

FIG. 20 is a bird's eye view illustrating the intermediate member 38 in a case of moving the second half intermediate member 382 in parallel with the first half intermediate member 381 having the same material and the same surface structure in the XY plane. XYZ coordinates in FIG. 20 are XYZ coordinates shown in FIG. 19. The reflection section reflected beam B31 is incident on the intermediate member 38 in such a manner that the center of the laser spot of the reflection section reflected beam B31 is on the boundary between the first half intermediate member 381 and the second half intermediate member 382.

Even if the second half intermediate member 382 is moved in parallel with the first half intermediate member 381 in the XY plane, as described above, the reflection section reflected beam B31 passing through the intermediate member 38 is propagated as two beams with different propagation directions. Therefore, the beam reflected in the positive reflection direction by the MEMS mirror section 12 is displayed as 2 division pulses on the display section (not shown).

In the optical scanning apparatus 3 of the third embodiment constituted as described above, by using merely a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

(Modification)

In the third embodiment, the surface of one or both of the first half intermediate member 381 and the second half intermediate member 382 may be the Fresnel surface.

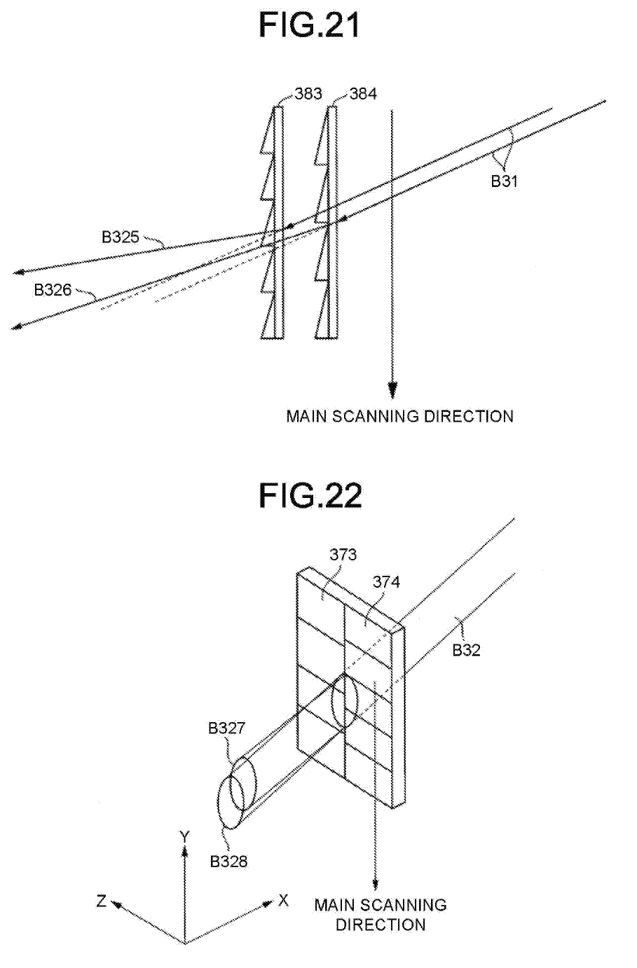

FIG. 21 is a diagram illustrating a state of refraction of the incident beam by a third half intermediate member 383 obtained by using the Fresnel surface as the surface of the first half intermediate member 381 and a fourth half intermediate member 384 obtained by using the Fresnel surface as the surface of the second half intermediate member 382 in the third embodiment. The third half intermediate member 383 and the fourth half intermediate member 384 are made of the same material. The third half intermediate member 383 and the fourth half intermediate member 384 each have a different Fresnel surface. The reflection section reflected beam B31 passes through the third half intermediate member 383 and becomes a transmitted light B325. The reflection section reflected beam B31 passes through the fourth half intermediate member 384 and becomes a transmitted light B326. The transmitted light B325 and the transmitted light B326 have different propagation directions because the third half intermediate member 383 and the fourth half intermediate member 384 have different Fresnel surfaces. Therefore, the reflection section reflected beam B31 passing through the intermediate member 38 is propagated as two beams having different propagation directions.

FIG. 22 is a bird's eye view of an intermediate member 38 having the third half intermediate member 383 and the fourth half intermediate member 384. In FIG. 22, the third half intermediate member 383 and the fourth half intermediate member 384 are arranged in contact with each other at the side surfaces thereof in the same ZY plane. The reflection section reflected beam B31 passes through the intermediate member 38 having the third half intermediate member 383 and the fourth half intermediate member 384 to become a transmitted light B327 and a transmitted light B328 having different propagation directions. Therefore, the beam reflected in the positive reflection direction by the MEMS mirror section 12 is displayed as 2 division pulses on the display section (not shown).

In the optical scanning apparatus 3 of the third embodiment constituted as described above, by using merely a single input port of the CPU, it is possible to distinguish the pulse signal generated by the beam reflected in the positive reflection direction from the pulse signal generated by the beam reflected in the negative reflection direction, and to determine an operation start position of the resonance vibration of the MEMS mirror section 12 without generating the chattering.

### Fourth Embodiment

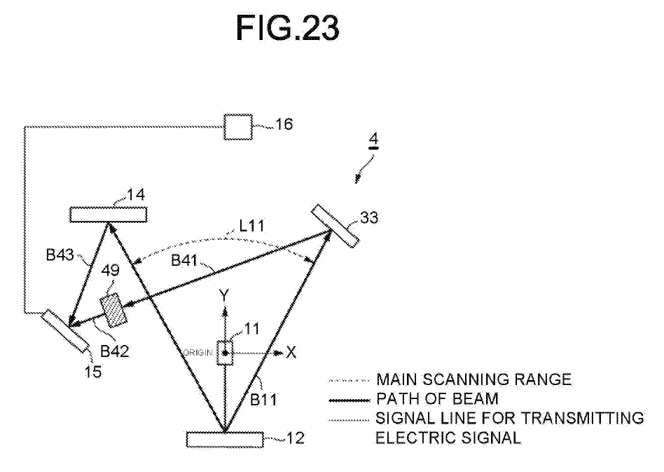

FIG. 23 is a diagram exemplifying the structure of an optical scanning apparatus 4 according to an embodiment. In FIG. 23, those which achieve the same function as either or both of the first embodiment and the third embodiment are denoted with the same reference numerals and the description thereof is omitted. The optical scanning apparatus 4 includes an intermediate lens section 49 as a component different from the first or the third embodiment.

The intermediate lens section 49 is a lens such as a convex lens or a concave lens. The intermediate lens section 49 is located between the reflection section 33 and the light receiving section 15 and is located in the optical path of the reflection section reflected beam B31. The intermediate lens section 49 adjusts the spot size of the beam spot of the reflection section reflected beam B31 on the surface of the light receiving section 15 by a lens function.

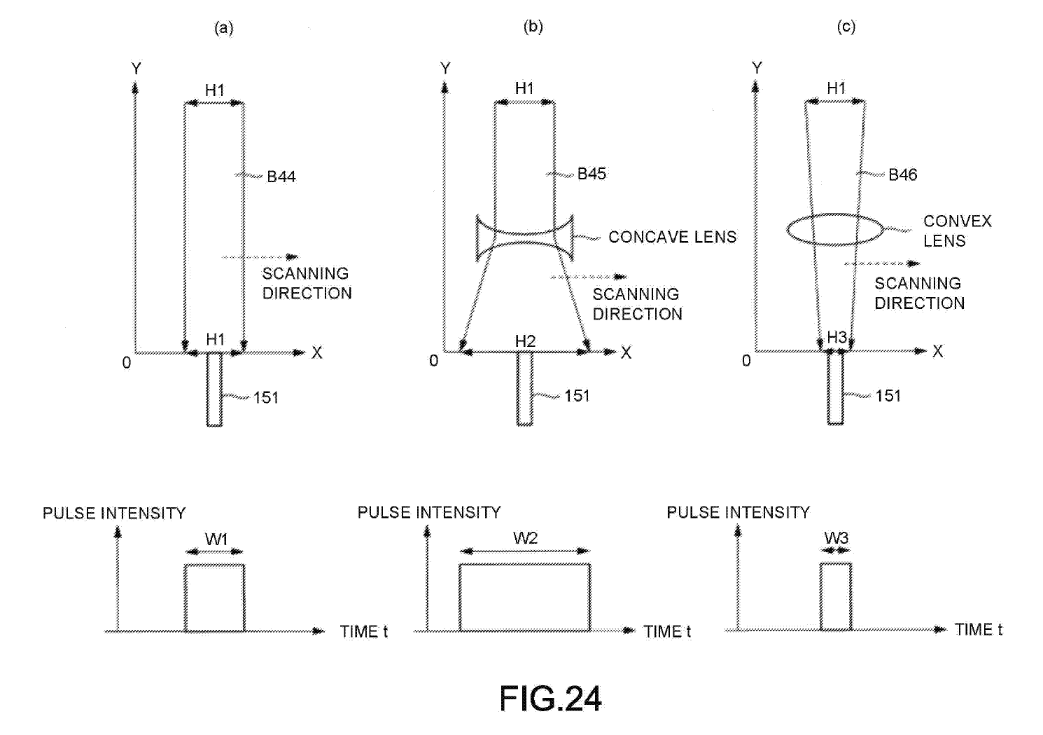

FIG. 24 is a diagram illustrating the relationship between a spot size of a beam spot of the light receiving section 15 and a pulse width of an electric signal generated by the beam. The light receiving section 15 includes a light receiving element 151. The light receiving element 151 may be, for example, a photodiode. FIG. 24(a) shows the pulse width generated if a beam B44 of a beam width H1 is received by the light receiving element 151 without passing through the lens. Since the beam B44 does not pass through the lens, the beam B44 forms a beam spot of spot size H1 on the light receiving element 151. In FIG. 24(a), the beam B44 with the beam width H1 is propagated in a negative direction along the Y axis and is received by the light receiving element 151 having a light receiving surface at Y=0. The beam B44 is scanned through the vibration of the MEMS mirror, for example. In FIG. 24(a), the beam B44 is scanned in an X axis positive direction. Therefore, the pulse width of photocurrent generated by the beam B44 is proportional to the time for the beam spot to pass through the light receiving surface of the light receiving element 151. Therefore, in FIG. 24(a), a pulse width W1 has a length on the time axis proportional to the size H1 of the beam spot.

FIG. 24(b) shows the pulse width generated if a beam B45 of the beam width H1 passes through a concave lens and is received by the light receiving element 151. The beam B45 passes through the concave lens and forms a beam spot of a spot size H2 on the light receiving element 151. In FIG. 24(b), the beam B45 is propagated in the negative direction along the Y axis and is received by the light receiving element 151 having the light receiving surface at Y=0. The beam B45 is scanned through the vibration of the MEMS mirror, for example. In FIG. 24(b), the beam B45 is scanned in the X axis positive direction. Therefore, a pulse width W2 of photocurrent generated by the beam 45 has a length on the time axis proportional to the size H2 of the beam spot. Therefore, H2>H1, and W2>W1.

Thus, the concave lens inserted in the optical path of the beam widens the pulse width of the binary photocurrent which is a pulse.

FIG. 24(c) shows a pulse width generated if a beam B46 of the beam width H1 passes through a convex lens and is received by the light receiving element 151. The beam B46 passes through the convex lens and forms a beam spot of a spot size H3 on the light receiving element 151 having the light receiving surface at Y=0. Since the convex lens is used, the relationship H3<H1 is satisfied. Therefore, the beam B46 scanned in the X axis positive direction generates a photocurrent which becomes a pulse of a pulse width W3 by being binarized. Since H3<H1, W3<W1.

Thus, the convex lens inserted in the optical path of the beam narrows the pulse width of the binary photocurrent which is a pulse.

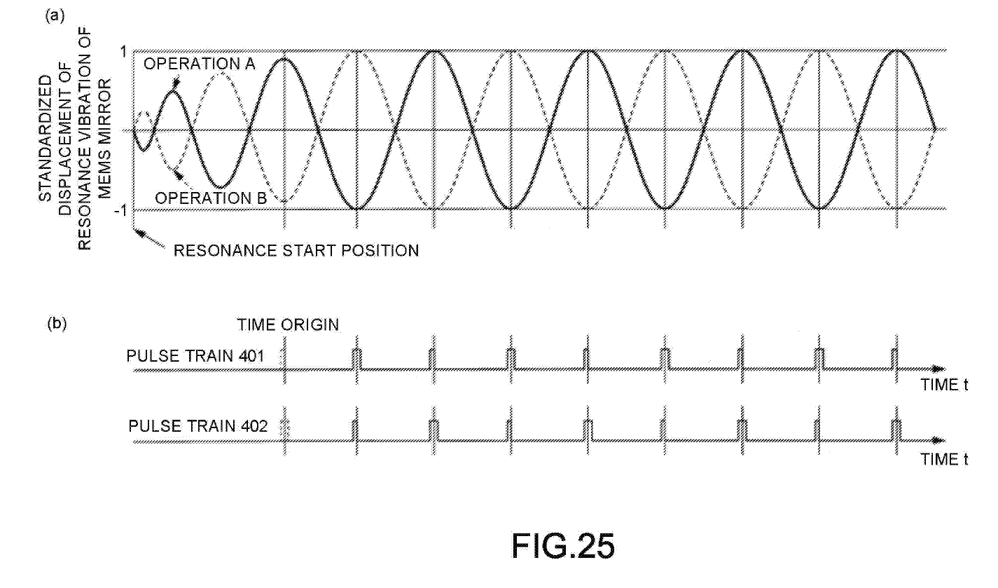

FIG. 25 is a diagram illustrating the relationship between the resonance vibration of the MEMS mirror and the generated pulse train in the optical scanning apparatus 4 according to a fourth embodiment. As described above, by inserting the concave lens or the convex lens in the optical path, the pulse width of the binary photocurrent which is a pulse is changed. Therefore, according to the arrangement of the optical scanning apparatus 4 of the embodiment, the beam reflected by the reflection section 33 and the beam reflected by the beam reflection plate 14 generate pulses having different pulse widths, respectively. FIG. 25(a) is the same as FIG. 4(a). FIG. 25(b) shows a concrete example of a pulse train (hereinafter, referred to as a “pulse train 401”) generated at the time of the operation A and a pulse train (hereinafter, referred to as a “pulse train 402”) generated at the time of the operation B if the intermediate lens section 49 is a convex lens. It is understood that the pulse train 403 and the pulse train 404 are different pulse trains.

In the optical scanning apparatus 4 of the fourth embodiment arranged as described above, by using merely a single input port of the CPU, it is possible to distinguish the pulse signal generated by the beam reflected in the positive reflection direction from the pulse signal generated by the beam reflected in the negative reflection direction, and to determine the operation start position of the resonance vibration of the MEMS mirror section 12.

(Modification)

The intermediate lens section 49 in the fourth embodiment may be arranged between the beam reflection plate 14 and the light receiving section 15, but not between the reflection section 33 and the light receiving section 15.

(Modification)

The intermediate lens sections 49 in the fourth embodiment may be not only arranged between the reflection section 33 and the light receiving section 15 but also between the beam reflection plate 14 and the light receiving section 15. In this case, a plurality of the intermediate lens sections 49 are arranged with concave lenses or convex lenses so as to form the beam spots of different spot sizes on the surface of the light receiving section 15.

According to at least one embodiment described above, it is possible to determine the operation start position of the

MEMS mirror by a single CPU input port by the difference in the pulse trains depending on the operation starting position of the resonance vibration of the MEMS mirror.

In the above-described embodiment, the mirror reflection section 13, the Fresnel mirror section 23, and the intermediate member 38 are each composed of two members, but the present invention is not limited thereto. The first half size reflection plate 131 and the second half size reflection plate 132 constituting the mirror reflection section 13 maybe integrally molded as a single member. In such a constitution, compared with a case of using two members, the cost can be reduced, and the effect of easy handling is achieved at the time of disposing the mirror reflection section 13 in the optical scanning apparatus 1. The same is true for the first half Fresnel reflection plate 231 and the second half Fresnel reflection plate 232 constituting the Fresnel mirror section 23, the first half intermediate member 381 and the second half intermediate member 382 constituting the intermediate member 38, and the third half intermediate member 383 and the fourth half intermediate member 384 constituting the intermediate member 38.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An optical scanning apparatus, comprising:
a MEMS mirror section configured to distribute a beam within a predetermined range by resonance vibration;
a light receiving section configured to receive the beam and convert the beam to an electric signal;
a first reflection section, arranged at one end of the predetermined range, configured to reflect the beam reflected by the MEMS mirror section towards the light receiving section;
a second reflection section, arranged at an other end of the predetermined range and on which the beam reflected by the MEMS mirror section is incident, configured to reflect the incident beam by separating the incident beam into two beams having different propagation paths in such a manner that beam spots of the two beams in the light receiving section are overlapped; and
a CPU input section having a single CPU port and in which the electric signal converted by the light receiving section is input.

2. The optical scanning apparatus according to claim 1, wherein
the second reflection section has two light receiving surfaces, and
the two light receiving surfaces are arranged at an angle with respect to each other.

3. The optical scanning apparatus according to claim 1, wherein
the second reflection section has two light receiving surfaces, and
the two light receiving surfaces are arranged to be parallel to each other.

4. The optical scanning apparatus according to claim 2, wherein
the second reflection section comprises a first mirror having one light receiving surface of the two light receiving surfaces and a second mirror having the other light receiving surface thereof.

5. The optical scanning apparatus according to claim 3, wherein
the second reflection section comprises a first mirror having one light receiving surface of the two light receiving surfaces and a second mirror having the other light receiving surface thereof.

6. The optical scanning apparatus according to claim 1, wherein
the light receiving surface of the second reflection section comprises a Fresnel surface.

7. The optical scanning apparatus according to claim 1, further comprising
a capacitor lens section with a capacitor lens located between the second reflection section and the light receiving section.

8. An optical scanning apparatus, comprising:
a MEMS mirror section configured to distribute a beam within a predetermined range by resonance vibration;
a light receiving section configured to receive the beam and convert the beam to an electric signal;
a first reflection section, arranged at one end of the predetermined range, configured to reflect the beam reflected by the MEMS mirror section towards the light receiving section;
a second reflection section, arranged at an other end of the predetermined range, configured to reflect the beam reflected by the MEMS mirror section towards the light receiving section;
an intermediate member, arranged between the first reflection section and the light receiving section or between the second reflection section and the light receiving section and on which the beam reflected by the first reflection section or the second reflection section is incident, configured to transmit the incident beam by separating the incident beam into two beams having different propagation paths in such a manner that beam spots of the two beams in the light receiving section are overlapped; and
a CPU input section having a single CPU port and in which the electric signal converted by the light receiving section is input.

9. The optical scanning apparatus according to claim 8, wherein
the intermediate member has two light receiving surfaces, and
the two light receiving surfaces are arranged at an angle with respect to each other.

10. The optical scanning apparatus according to claim 8, wherein
the intermediate member has two light receiving surfaces, and
the two light receiving surfaces are parallel to each other.

11. The optical scanning apparatus according to claim 9, wherein
the intermediate member comprises a first mirror having one light receiving surface of the two light receiving surfaces and a second mirror having the other light receiving surface of the two light receiving surfaces.

12. The optical scanning apparatus according to claim 10, wherein
the intermediate member comprises a first mirror having one light receiving surface of the two light receiving surfaces and a second mirror having the other light receiving surface of the two light receiving surfaces.

13. The optical scanning apparatus according to claim 8, wherein
the light receiving surface of the intermediate member is a Fresnel surface.

14. The optical scanning apparatus according to claim 8, wherein
the intermediate member comprises a convex lens or a concave lens.

15. The optical scanning apparatus according to claim 8, wherein the intermediate member has two light receiving surfaces shifted relative to each other in a main scanning direction.

16. The optical scanning apparatus according to claim 1, wherein the second reflection section has two light receiving surfaces shifted relative to each other in a main scanning direction.

17. The optical scanning apparatus according to claim 1, wherein the beam spots of the two beams in the light receiving section have a different spot size.

18. The optical scanning apparatus according to claim 8, wherein the beam spots of the two beams in the light receiving section have a different spot size.

19. A method of optical scanning, comprising:
distributing via a MEMS mirror section a beam within a predetermined range by resonance vibration;
reflecting the beam reflected by the MEMS mirror section at one end of the predetermined range towards a light receiving section;
reflecting the beam reflected by the MEMS mirror section at an other end of the predetermined range by separating the incident beam into two beams having different propagation paths in such a manner that beam spots of the two beams in the light receiving section are overlapped;
converting the beams incident on the light receiving section into an electric signal; and
inputting the electric signal converted by the light receiving section into a CPU input section having a single CPU port.
